(19) United States
(12) Patent Application Publication
(10) Pub. No.: US 2025/0205792 A1
(43) Pub. Date: Jun. 26, 2025

(54) SUPERHARD CUTTING ELEMENTS, CUTTING TOOLS INCLUDING THE SAME, AND METHODS OF USING THE SAME

(71) Applicant: US Synthetic Corporation, Orem, UT (US)

(72) Inventors: Edwin Sean COX, Spanish Fork, UT (US); Jason LOTT, Payson, UT (US); Jeff CLARK, Orem, UT (US); Verl DALLIN, Spanish Fork, UT (US)

(21) Appl. No.: 18/846,830

(22) PCT Filed: Mar. 9, 2023
(86) PCT No.: PCT/US2023/014870

§ 371 Date: Sep. 13, 2024

Related U.S. Application Data
(60) Provisional application No. 63/320,914, filed on Mar. 17, 2022.

(51) Int. Cl. B23C 5/22

(52) U.S. Cl. CPC B23C 5/22

(57) ABSTRACT

Embodiments include superhard cutting elements and cutting tools including the cutting elements. In an embodiment, a cutting element includes a superhard table defining at least one cutting edge, a top surface at least partially defined by the superhard table, a bottom surface opposite the top surface, at least one lateral surface extending from or nearly from the top surface to or nearly to the bottom surface, and an opening extending from the top surface to the bottom surface that is spaced from the lateral surface. The opening is at least partially defined by at least one shaft surface extending from or nearly from the bottom surface and at least one tapered countersink surface extending from or nearly from the shaft surface. The tapered countersink surface exhibits a countersink angle measured between opposing portions of the at least one tapered countersink surface that is greater than about 45°.

### BACKGROUND

Cutting tools are conventionally used in machining operations to remove material and form desired shapes and surfaces of a given object. For example, milling is a machining process wherein material is progressively removed in the form of “chips” to form a shape or surface from a given volume of material-often referred to as a workpiece. This may be accomplished by feeding the workpiece into a rotating cutting tool (or vice-versa), often in a direction that is perpendicular to the axis of rotation of the cutting tool. Various types of cutters may be employed in milling operations, but most cutting tools include a body and one or more teeth (or cutting elements-which may be brazed or mechanically attached to the body) that cut into and remove material from the workpiece as the teeth of the rotating cutter engage the workpiece.

Nearly any solid material may be machined, including metals, plastics, composites and natural materials. Some materials are more easily machined than other types of materials, and the type of material being machined may dictate, to a large extent, the process that is undertaken to machine the workpiece, including the choice of cutting tool. For example, titanium and titanium alloys, while exhibiting a number of desirable mechanical and material characteristics, are notoriously difficult to machine.

While there are numerous reasons for the difficulty in milling titanium materials, some of them not entirely understood, some reasons may include its high strength, chemical reactivity with cutter materials, and low thermal conductivity. These characteristics tend to reduce the life of the cutter. Additionally, the relatively low Young's modulus of titanium materials is believed to lead to “chatter” in the cutting tool, often resulting in a poor surface finish of a machined workpiece. Further, the “chips” that are typically formed in machining processes such as milling are not typically small broken chips but, rather, long continuous chips which can become tangled in the machinery, posing a safety hazard and making it difficult to conduct automatic machining of titanium materials.

While there have been various attempts to provide cutting tools that provide desirable characteristics for machining various materials, including normally difficult-to-machine materials such as titanium, there is a continued desire in the industry to provide improved cutting tools for machining of a variety of materials and for use in a variety of cutting processes.

### SUMMARY

Embodiments are directed to superhard cutting elements, cutting tools including the cutting elements, and methods of using the cutting tools. In an embodiment, a cutting element is disclosed. The cutting element includes a superhard table defining at least one cutting edge, a top surface at least partially defined by the superhard table, a bottom surface opposite the top surface, at least one lateral surface extending from or nearly from the top surface to or nearly to the bottom surface, and an opening extending from the top surface to the bottom surface that is spaced from the at least one lateral surface. The opening is at least partially defined by at least one shaft surface extending from or nearly from the bottom surface and at least one tapered countersink surface extending from or nearly from the at least one shaft surface. The at least one tapered countersink surface exhibits a countersink angle measured between opposing portions of the at least one tapered countersink surface that is greater than about 45°.

In an embodiment, a cutting tool is disclosed. The cutting tool includes a cutting tool body. The cutting tool also includes at least one cutting element attached to the cutting tool body. The cutting element includes a superhard table defining at least one cutting edge, a top surface at least partially defined by the superhard table, a bottom surface opposite the top surface, at least one lateral surface extending from or nearly from the top surface to or nearly to the bottom surface, and an opening extending from the top surface to the bottom surface that is spaced from the at least one lateral surface. The opening is at least partially defined by at least one shaft surface extending from or nearly from the bottom surface and at least one tapered countersink surface extending from or nearly from the at least one shaft surface. The at least one tapered countersink surface exhibits a countersink angle measured between opposing portions of the at least one tapered countersink surface that is greater than about 45°. The cutting tool also includes a fastener attaching the at least one cutting element to the body. The fastener includes a shaft and a head having a tapered surface at least partially abutting the at least one tapered countersink surface.

In an embodiment, a method of removing material from a workpiece is disclosed. The method includes providing a cutting tool. The cutting tool includes a body and at least one cutting element. The cutting element includes a superhard table defining at least one cutting edge, a top surface at least partially defined by the superhard table, a bottom surface opposite the top surface, at least one lateral surface extending from or nearly from the top surface to or nearly to the bottom surface, and an opening extending from the top surface to the bottom surface that is spaced from the at least one lateral surface. The opening is at least partially defined by at least one shaft surface extending from or nearly from the bottom surface and at least one tapered countersink surface extending from or nearly from the at least one shaft surface. The at least one tapered countersink surface exhibits a countersink angle measured between opposing portions of the at least one tapered countersink surface that is greater than about 45°. The cutting tool also includes a fastener attaching the at least one cutting element to the body. The fastener includes a shaft and a head having a tapered surface at least partially abutting the at least one tapered countersink surface. The method also includes rotating at least one of the cutting tool or the workpiece about an axis and engaging the workpiece with the rotating cutting tool.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the present disclosure wherein identical reference numerals refer to identical or similar elements or features in different views or embodiments shown in the drawings.

FIGS. 1A and 1B are top and side elevational views, respectively, of a cutting element, according to an embodiment.

FIG. 1C is a cross-sectional view of the cutting element taken along plane 1C-1C shown in FIG. 1A, according to an embodiment.

FIG. 2 is a cross-sectional view of a cutting element, according to an embodiment.

FIG. 3 is a schematic illustration of a vertical milling machine and operation thereof, according to an embodiment.

FIG. 4 is a schematic illustration of a horizontal milling machine and operation thereof, according to an embodiment.

FIGS. 5A and 5B are isometric and side elevational views, respectively, of a cutting tool, according to an embodiment.

### DETAILED DESCRIPTION

Embodiments are directed to superhard cutting elements, cutting tools including the cutting elements, and methods of using the cutting tools. An example cutting element includes a superhard table that defines at least one cutting edge. The cutting element includes a top surface (e.g., rake surface) at least partially defined by the superhard table, a bottom surface opposite the top surface, and at least one lateral surface extending from or nearly from the top surface to or nearly to the bottom surface. The cutting element defines an opening extending through the cutting element (e.g., from the top surface to the bottom surface). The opening is at least partially defined by at least one shaft surface extending from or nearly from the bottom surface and at least one tapered countersink surface.

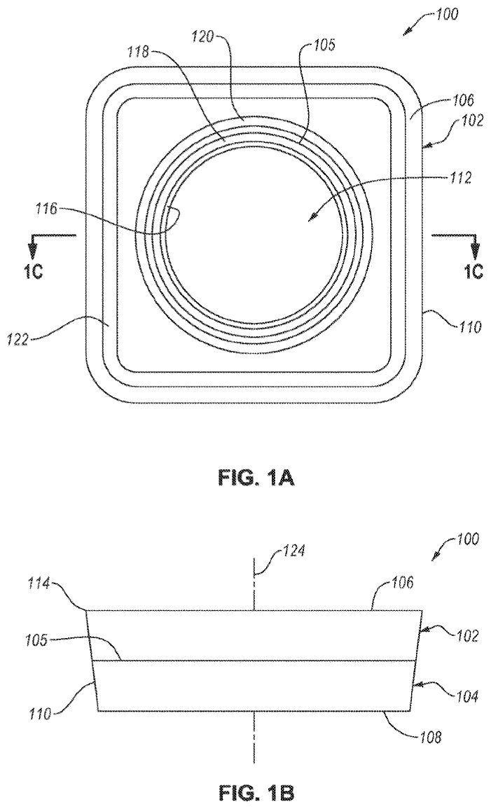

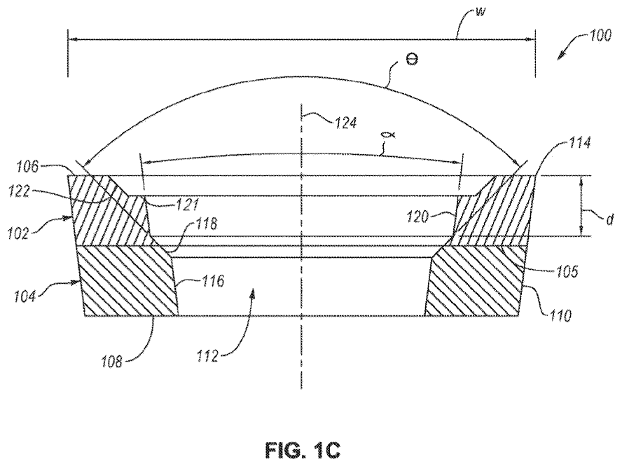

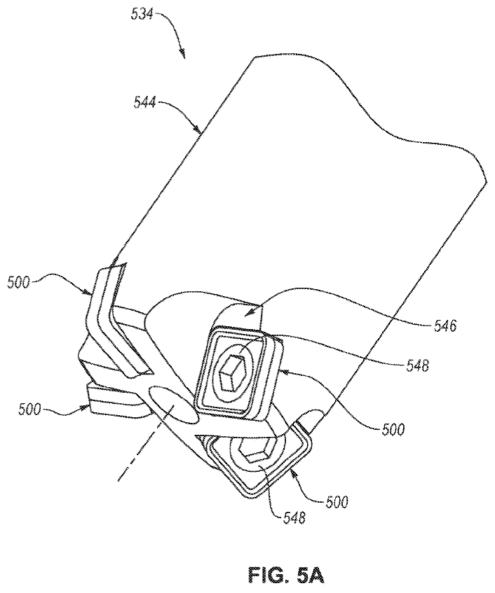

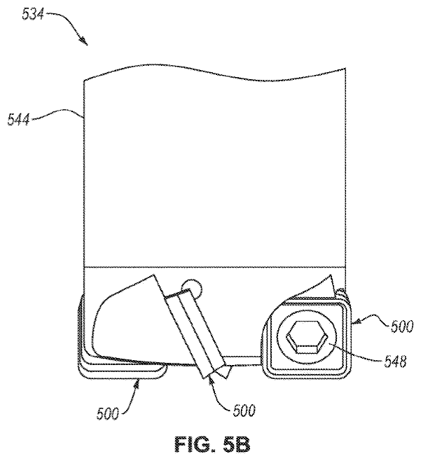

FIGS. 1A and 1B are top and side elevational views, respectively, of a cutting element 100, according to an embodiment. FIG. 1C is a cross-sectional view of the cutting element 100 taken along plane 1C-1C shown in FIG. 1A, according to an embodiment. The cutting element 100 includes a superhard table 102 attached to a substrate 104. The cutting element 100 includes a top surface 106 (e.g., rake surface), a bottom surface 108, and at least one lateral surface 110 extending from or nearly from (e.g., spaced from by a chamfer or other similar surface) the top surface 106 to or nearly to (e.g., spaced from by a chamfer or other similar surface) the bottom surface 108. The cutting element 100 also defines an opening 112 configured to receive a fastener (e.g., fastener 548 of FIGS. 5A and 5B). The opening 112 extends from the top surface 106 to the bottom surface 108. The opening 112 may be spaced from the lateral surface 110.

The superhard table 102 may comprise a superhard, superabrasive material (e.g., material exhibiting a hardness equal to or greater than tungsten carbide). For example, the superhard table 102 may include one or more of polycrystalline diamond (PCD), polycrystalline cubic boron nitride, or other superabrasive material.

The cutting element 100 may include a substrate 104 attached to the superhard table 102. In some embodiments, the cutting element 100 may comprise a polycrystalline diamond compact (PDC) including a PCD table to which the substrate 104 is bonded. In some embodiments, an interface 105 between the superhard table 102 and the substrate 104 may be substantially flat or planar. In other embodiments, the interface 105 may be domed or curved. In other embodiments, the interface 105 between the superhard table 102 and the substrate 104 may include a plurality of raised features or recessed features (e.g., dimples, grooves, ridges, etc.).

In one particular example, the superhard table 102 may exhibit a thickness (i.e., from the top surface 106 to the interface 105 between the superhard table 102 and the substrate 104) that is about 1 mm or greater. In other embodiments, the superhard table 102 exhibits a thickness of 1.25 mm or greater, about 1.5 mm or greater, about 1.75 mm or greater, about 2 mm or greater, about 2.25 mm or greater, about 2.5 mm or greater, about 2.75 mm or greater, about 3 mm or greater, about 3.25 mm or greater, about 3.5 mm or greater, about 3.75 mm or greater, about 4 mm or greater, about 4.5 mm or greater, about 5 mm or greater, about 5.5 mm or greater, about 6 mm or greater, about 6.5 mm or greater, about 7 mm or greater, about 7.5 mm or greater, or in ranges of about 1 mm to about 1.5 mm, about 1.25 mm to about 1.75 mm, about 1.5 mm to about 2 mm, about 1.75 mm to about 2.25 mm, about 2 mm to about 2.5, about 2.25 mm to about 2.75 mm, about 2.5 mm to about 3 mm, about 2.75 mm to about 3.25 mm, about 3 mm to about 3.5 mm, about 3.25 mm to about 3.75, about 3.5 mm to about 4 mm, about 3.75 mm to about 4.5 mm, about 4 mm to about 5 mm, about 4.5 mm to about 5.5 mm, about 5 mm to about 6 mm, about 5.5 mm to about 6.5 mm, about 6 mm to about 7 mm, or about 6.5 mm to about 7.5 mm. Examples of methods for forming relatively thick PCDs may be found in U.S. Pat. No. 9,080,385, the disclosure of which is incorporated by reference herein in its entirety.

The PCD superhard table 102 includes a plurality of directly bonded-together diamond grains exhibiting diamond-to-diamond bonding therebetween (e.g., sp³ bonding), which define a plurality of interstitial regions. A portion of, or substantially all of, the interstitial regions of the PCD superhard table 102 may include a metal-solvent catalyst or a metallic infiltrant disposed therein that is infiltrated from the substrate 104 or from another source during fabrication. For example, the metal-solvent catalyst or metallic infiltrant may be selected from iron, nickel, cobalt, and alloys of the foregoing. In some embodiments, the PCD superhard table 102 may further include thermally-stable diamond in which the metal-solvent catalyst or metallic infiltrant has been partially or substantially completely depleted from a selected surface or volume of the PCD superhard table 102, such as via an acid leaching process. Thermally-stable PCD may also be sintered with one or more alkali metal catalysts. In some embodiments, the catalyst-depleted region may exhibit a depth that is substantially conformal with an outer surface of the PCD superhard table 102. In other embodiments, the catalyst-depleted region may generally extend a desired depth from a plane extending through the uppermost portions of the superhard table 102 (through the peripheral edges of a cutting edge 114). Thus, removal of the catalyst or infiltrant may be done prior to or after the forming of the structures and features (e.g., the opening 112) of the cutting element 100. In some embodiments, the catalyst-depleted region may generally extend a desired depth from at least a portion of at least one surface defining the opening 112.

In an embodiment, the leached thermally-stable region may extend inwardly from the top surface 106 to a selected depth. The selected depth of the thermally-stable region may be about 50 μm to about 1,500 μm. More specifically, in some embodiments, the selected depth is about 50 μm to about 900 μm, about 200 μm to about 600 μm, or about 600 μm to about 1200 μm. In an embodiment, the leached thermally-stable region may extend completely through the superhard table 102. The leaching may be performed in a suitable acid, such as aqua regia, nitric acid, hydrofluoric acid, or mixtures of the foregoing.

In some embodiments, PDCs which may be used as the cutting element 100 may be formed in an HPHT process. For example, diamond particles may be disposed adjacent to the substrate 104, and subjected to an HPHT process to sinter the diamond particles to form the PCD table and bond the PCD table to the substrate 104, thereby forming the PDC. The temperature of the HPHT process may be at least about 1000° C. (e.g., about 1200° C. to about 1600° C.) and the cell pressure, or the pressure in the pressure-transmitting medium (e.g., a refractory metal can, graphite structure, pyrophyllite, etc.), of the HPHT process may be at least 4.0 GPa (e.g., about 5.0 GPa to about 12 GPa or about 7.5 GPa to about 11 GPa) for a time sufficient to sinter the diamond particles. The pressures values employed in the HPHT processes disclosed herein refer to the pressure in the pressure transmitting medium at room temperature (e.g., about 25° C.) with application of pressure using an ultra-high pressure press and not the pressure applied to the exterior of the cell assembly. The actual pressure in the pressure transmitting medium at sintering temperature may be slightly higher.

In some embodiments, the diamond particles may exhibit an average particle size of about 50 μm or less, such as about 30 μm or less, about 20 μm or less, about 10 μm to about 20 μm, about 10 μm to about 18 μm, about 12 μm to about 18 μm, or about 15 μm to about 18 μm. In some embodiments, the average particle size of the diamond particles may be about 10 μm or less, such as about 2 μm to about 5 μm or submicron. In some embodiments, the diamond particles may exhibit multiple sizes and may comprise, for example, a relatively larger size and at least one relatively smaller size. As used herein, the phrases “relatively larger” and “relatively smaller” refer to particle sizes (by any suitable method) that differ by at least a factor of two (e.g., 30 μm and 15 μm). According to various embodiments, the mass of diamond particles may include a portion exhibiting a relatively larger size (e.g., 30 μm, 20 μm, 15 μm, 12 μm, 10 μm, 8 μm) and another portion exhibiting at least one relatively smaller size (e.g., 6 μm, 5 μm, 4 μm, 3 μm, 2 μm, 1 μm, 0.9 μm, 0.8 μm, 0.7 μm, 0.6 μm, 0.5 μm, less than 0.5 μm, 0.4 μm, 0.3 μm, 0.2 μm, 0.1 μm, less than 0.1 μm). For example, in one embodiment, the diamond particles may include a portion exhibiting a relatively larger size between about 10 μm and about 40 μm and another portion exhibiting a relatively smaller size between about 0.5 μm and 4 μm. In some embodiments, the diamond particles may comprise three or more different sizes (e.g., one relatively larger size and two or more relatively smaller sizes), without limitation. The PCD table so-formed after sintering may exhibit an average diamond grain size that is the same or similar to any of the foregoing diamond particle sizes and distributions. More details about diamond particle sizes and diamond particle size distributions that may be employed are disclosed in U.S. Pat. No. 9,346,149, the disclosure of which is incorporated by reference herein in its entirety.

In some embodiments, the diamond grains of the resulting superhard table 102 may exhibit an average grain size that is equal to or less than approximately 12 μm and include cobalt content of greater than about 7 weight percent (wt. %) cobalt. In some other embodiments, the diamond grains of the resulting superhard table 102 may exhibit an average grain size that is equal to or greater than approximately 20 μm and include cobalt content of less than approximately 7 wt. %. In some embodiments, the diamond grains of the resulting table may exhibit an average grains size that is approximately 10 μm to approximately 20 μm.

In some embodiments, tables 170 may be sintered as PCD tables at a pressure of at least about 7.5 GPa, may exhibit a coercivity of 115 Oe or more, a high-degree of diamond-to-diamond bonding, a specific magnetic saturation of about 20 G·cm³/g or less (e.g., about 15 G·cm³/g or less) and a metal-solvent catalyst content of about 7.5 wt. % or less. The PCD may include a plurality of diamond grains directly bonded together via diamond-to-diamond bonding to define a plurality of interstitial regions. At least a portion of the interstitial regions or, in some embodiments, substantially all of the interstitial regions may be occupied by a metal-solvent catalyst, such as iron, nickel, cobalt, or alloys of any of the foregoing metals. For example, the metal-solvent catalyst may be a cobalt-based material including at least 50 wt. % cobalt, such as a cobalt alloy.

The metal-solvent catalyst that occupies the interstitial regions may be present in the PCD in an amount of about 7.5 wt. % or less. In some embodiments, the metal-solvent catalyst may be present in the PCD in an amount of about 3 wt. % to about 7.5 wt. %, such as about 3 wt. % to about 6 wt. %. In other embodiments, the metal-solvent catalyst content may be present in the PCD in an amount less than about 3 wt. %, such as about 1 wt. % to about 3 wt. % or a residual amount to about 1 wt. %. By maintaining the metal-solvent catalyst content below about 7.5 wt. %, the PCD may exhibit a desirable level of thermal stability.

Generally, as the sintering pressure that is used to form the PCD increases, the coercivity may increase and the magnetic saturation may decrease. The PCD defined collectively by the bonded diamond grains and the metal-solvent catalyst may exhibit a coercivity of about 115 Oe or more and a metal-solvent catalyst content of less than about 7.5 wt. % as indicated by a specific magnetic saturation of about 20 G·cm³/g or less (e.g., about 15 G·cm³/g or less). In a more detailed embodiment, the coercivity of the PCD may be about 115 Oe to about 250 Oe and the specific magnetic saturation of the PCD may be greater than 0 G·cm³/g to about 20 G·cm³/g (e.g., greater than 0 G·cm³/g to about 15 G·cm³/g). In an even more detailed embodiment, the coercivity of the PCD may be about 115 Oe to about 175 Oe and the specific magnetic saturation of the PCD may be about 5 G·cm³/g to about 20 G·cm³/g (e.g., about 5 G·cm³/g to about 15 G·cm³/g). In yet an even more detailed embodiment, the coercivity of the PCD may be about 155 Oe to about 175 Oe and the specific magnetic saturation of the PCD may be about 10 G·cm³/g to about 20 G·cm³/g (e.g., about 10 G·cm³/g to about 15 G·cm³/g). The specific permeability (i.e., the ratio of specific magnetic saturation to coercivity) of the PCD may be about 0.10 or less, such as about 0.060 to about 0.090. Despite the average grain size of the bonded diamond grains being less than about 30 μm, the metal-solvent catalyst content in the PCD may be less than about 7.5 wt. % resulting in a desirable thermal stability.

In one embodiment, diamond particles having an average particle size of about 18 μm to about 20 μm are positioned adjacent to a cobalt-cemented tungsten carbide substrate and subjected to an HPHT process at a temperature of about 1390° C. to about 1430° C. and a cell pressure of about 7.8 GPa to about 8.5 GPa. The PCD so-formed as a PCD table bonded to the substrate may exhibit a coercivity of about 155 Oe to about 175 Oe, a specific magnetic saturation of about 10 G·cm³/g to about 20 G·cm³/g (e.g., about 10 G·cm³/g to about 15 G·cm³/g), and a cobalt content of about 5 wt. % to about 7.5 wt. %.

In one or more embodiments, a specific magnetic saturation constant for the metal-solvent catalyst in the PCD may be about 185 G·cm³/g to about 215 G·cm³/g. For example, the specific magnetic saturation constant for the metal-solvent catalyst in the PCD may be about 195 G·cm³/g to about 205 G·cm³/g. It is noted that the specific magnetic saturation constant for the metal-solvent catalyst in the PCD may be composition dependent.

Generally, as the sintering pressure is increased above 7.5 GPa, a wear resistance of the PCD so-formed may increase. For example, the Gᵣₐₜᵢₒ may be at least about 4.0×10⁶, such as about 5.0×10⁶ to about 15.0×10⁶ or, more particularly, about 8.0×10⁶ to about 15.0×10⁶. In some embodiments, the Gᵣₐₜᵢₒ may be at least about 30.0×10⁶. The Gᵣₐₜᵢₒ is the ratio of the volume of workpiece cut (e.g., between about 470 in³ of barre granite to about 940 in³ of barre granite) to the volume of PCD worn away during the cutting process. It is noted that while such a process may involve a so-called “granite log test,” this process is still applicable for determining the Gᵣₐₜᵢₒ of the PCD even though the cutter may be intended for use in metal cutting processes rather than rock cutting or drilling.

The material characteristics discussed herein, as well as other characteristics that may be provided in a cutting element 100, including processes for measuring and determining such characteristics, as well as methods of making such cutting elements, are described in U.S. Pat. Nos. 7,866,418, 8,297,382, and 9,315,881, the disclosure of each of which is incorporated by reference herein in its entirety.

In some embodiments, the superhard table 102 may comprise high density polycrystalline diamond. For example, in some embodiments, the superhard table 102 may comprise approximately 95 percent diamond by volume (vol. %) or greater. In some embodiments, the superhard table 102 may comprise approximately 98 vol. % diamond or greater. In some embodiments, the superhard table 102 may comprise approximately 99 vol. % diamond or greater. In other embodiments, the table may comprise polycrystalline diamond or relatively low diamond content. For example, in some embodiments, the superhard table 102 may comprise less than 95 percent diamond by volume (vol. %).

In some embodiments, the superhard table 102 may be integrally formed with the substrate 104 such as discussed above. In some other embodiments, the superhard table 102 may be a pre-formed table that has been HPHT bonded to the substrate 104 in a second HPHT process after being initially formed in a first HPHT process. For example, the superhard table 102 may be a pre-formed PCD table that has been leached to substantially completely remove the metal-solvent catalyst used in the manufacture thereof and subsequently HPHT bonded or brazed to the substrate 104 in a separate process.

The substrate 104 may comprise any number of different materials, and may be integrally formed with, or otherwise bonded or connected to, the superhard table 102. Materials suitable for the substrate 104 may include, without limitation, cemented carbides, such as tungsten carbide, titanium carbide, chromium carbide, niobium carbide, tantalum carbide, vanadium carbide, or combinations thereof cemented with iron, nickel, cobalt, or alloys thereof.

As depicted in FIG. 1A, the cutting element 100 may be configured to exhibit a substantially square outer profile, a rounded square outer profile, and/or a substantially rounded square outer profile when viewed from above. Such a geometry provides multiple cutting edges 114, which may be indexed relative to a cutting tool body (e.g., cutting tool body 544 of FIGS. 5A and 5B) for extended service of the cutting element 100. For example, as one cutting edge 114 becomes worn or damaged, the cutting element 100 may be rotated relative to the tool body such that a new cutting edge 114 may be presented to a workpiece for the cutting and removal of material therefrom. It is noted that other shapes and outer profiles are contemplated including, for example, generally circular, generally curved, generally triangular, generally hexagonal, generally octagonal, and other generally regular or generally irregular polygons.

As previously discussed, the cutting element 100 defines an opening 112 formed in the superhard table 102 and the substrate 104 to accommodate a fastener for coupling the cutting element 100 to a cutting tool body. The cutting element 100 includes one or more surfaces defining the opening 112. For example, in the illustrated embodiment, the opening 112 is defined by at least at least one shaft surface 116 and at least one tapered countersink surface 118. The shaft surface 116 extends upwardly (e.g., generally towards the top surface 106 and/or a plane extending through the uppermost portions of the superhard table 102) from or nearly from the bottom surface 108. The tapered countersink surface 118 generally extends upwardly from or nearly from the shaft surface 116. The opening 112 may optionally be defined by one or more additional surfaces, such as at least one tapered bore surface 120 extending upwardly from or nearly from the tapered countersink surface 118 and/or at least one tapered cutting feature surface 122 extending inwardly from or nearly from the top (e.g., rake) surface 106. It is noted that a chamfer or radiused surface may extend between adjacent surfaces. For example, a chamfer or radiused surface may extend between at least one of the bottom surface 108 and the shaft surface 116, the shaft surface 116 and the tapered countersink surface 118, the tapered countersink surface 118 and the tapered bore surface 120, the tapered bore surface 120 and the tapered cutting feature surface 122, the tapered bore surface 120 and/or the tapered cutting feature surface 122 and an optional surface 121 extending between the tapered bore surface 120 and the tapered cutting feature surface 122, or the tapered cutting feature surface 122 and the top surface 106.

The fastener disposed in the opening 112 may include a tapered surface that generally corresponds to the tapered countersink surface 118. Rotating the fastener may cause the tapered surface of the fastener to apply a force to the tapered countersink surface 118. It has been found that, in some embodiments, the force applied from the tapered surface of the fastener to the tapered countersink surface 118 may cause the cutting element 100 to split or otherwise fail when a relatively low torque is applied to the fastener. For example, it has been found that, in some embodiments, the cutting element 100 may split or otherwise fail when a torque of less than 5 Newton meters (Nm) is applied to the fastener. In other words, in such embodiments, the torque applied using a handheld wretch to the fastener may be sufficient to cause the cutting element 100 may split or otherwise fail. In other embodiments, the cutting element 100 may include one or more features, as discussed in more detail below (e.g., the countersink angle θ, the depth d of the tapered countersink surface 118, the width W of the cutting element 100, etc.), that prevent or at least inhibit splitting or failing of the cutting element 100 when a large torque is applied to the fastener. As used herein, a large torque refers to a torque that is about 2.5 Nm or greater, about 3.0 Nm or greater, about 5 Nm or greater, about 6 Nm or greater, about 7 Nm or greater, about 8 Nm or greater, about 9 Nm or greater, about 10 Nm or greater, about 12 Nm or greater, about 15 Nm or greater, or in ranges of about 5 Nm to about 7 Nm, about 6 Nm to about 8 Nm, about 7 Nm to about 9 Nm, about 8 Nm to about 10 Nm, about 9 Nm to about 12 Nm, or about 10 Nm to about 15 Nm.

As previously discussed, the cutting element 100 includes the at least one shaft surface 116 that defines a portion of the opening 112. The shaft surface 116 extends upwardly from the bottom surface 108 or may extend upwardly from a location nearly from the bottom surface 108 (e.g., the cutting element 100 includes a chamfer or radiused surface extending between the bottom surface 108 and the shaft surface 116). The shaft surface 116 is configured to receive a shaft of the fastener. As such, the shaft surface 116 may exhibit a shape that corresponds to the shape of the shaft and a size that is equal to or slightly larger than the shaft. For example, the shaft surface 116 may exhibit a generally cylindrical shape when the shaft of the fastener exhibits a generally cylindrical shape or a generally tapered shape (e.g., generally truncated conical shape) when the shaft of the fastener exhibits a generally tapered shape (e.g., a generally conical shape).

The shaft surface 116 may be formed entirely by the substrate 104 (as illustrated) or at least partially formed by the superhard table 102 so that the shaft surface 116 is formed in both the substrate 104 and the superhard table 102. In an example, whether the shaft surface 116 is at least partially formed by the superhard table 102 depends on the thickness of the superhard table 102. For instance, increasing the thickness of the superhard table 102 shifts the interface 105 between the superhard table 102 downwards (i.e., towards the bottom surface 108) which may cause the superhard table 102 to at least partially form the shaft surface 116.

As previously discussed, the cutting element 100 includes the at least one tapered countersink surface 118 that defines a portion of the opening 112. The tapered countersink surface 118 extends upwardly from the shaft surface 116 or may extend from a location nearly from the shaft surface 116 (e.g., when the cutting element 100 includes a chamfer or radiused surface extending between the shaft surface 116 and the tapered countersink surface 118). In an example, the tapered countersink surface 118 is distinguishable from the shaft surface 116 in that the angle that the tapered countersink surface 118 extends relative to the central axis 124 is different (e.g., greater) than the angle that the shaft surface 116 extends relative to the central axis 124. For instance, the tapered countersink surface 118 may extend at a non-parallel angle relative to the central axis 124 while the shaft surface 116 may extend at a generally parallel angle relative to the central axis 124. The tapered countersink surface 118 may form a generally truncated conical shape.

The tapered countersink surface 118 is configured to receive a head of the fastener. As previously discussed, the head of the fastener may include a tapered surface. The tapered countersink surface 118 may be configured to abut the tapered surface of the head of the fastener. The tapered countersink surface 118 may generally correspond to the tapered surface of the head of the fastener. As such, the tapered countersink surface 118 may exhibit a shape that corresponds to the shape of the shaft and a size that is equal to or larger than the tapered surface of the head of the fastener.

The tapered countersink surface 118 may exhibit a countersink angle θ. The countersink angle θ is the smallest angle between opposing portions of the tapered countersink surface 118. For example, the countersink angle θ may be double the smallest angle measured between the tapered countersink surface 118 and the central axis 124. The countersink angle θ may correspond to a similar or identical angle of the tapered surface of the head of the fastener. In other words, the countersink angle θ may be selected based on the fastener used to secure the cutting element 100 to the cutting tool body. In an embodiment, the cutting element 100 may be configured to be used with a common fastener (i.e., a fastener having a smallest angle of 40° angle measured between opposing portions of the tapered surface of the head thereof) since such the common fastener is commonly used to secure cutting elements to a cutting tool body. In such an embodiment, the countersink angle θ of the tapered countersink surface 118 may be about 40°, thereby allowing the tapered countersink surface 118 to contact the tapered surface of the head of the common fastener. However, it has been found that the 40° angle of common fastener may increase the likelihood that the common fastener causes the cutting element 100 to split or otherwise fail when a torque of about 5 Nm or less is applied to the common fastener.

It has also been found that increasing the angle measured between opposing portions of the tapered surface of the head of a fastener to be 45° or greater and, more particularly, to be about 50° or greater or about 60° or greater may decrease the likelihood that the cutting element 100 splits or otherwise fails compared to the common fastener. In other words, increasing the angle measured between opposing portions of the tapered surface of the head of the fastener allows a large torque to be applied to the fastener without or substantially without causing the cutting element 100 to split or otherwise fail. As such, in an embodiment, the cutting element 100 is configured to be used with a fastener having a smallest angle measured between opposing portions of the tapered surface of the head thereof that is about 45° or greater or, more preferably, about 50° or greater or about 60° or greater. In such an embodiment, the countersink angle θ of the tapered countersink surface 118 may selected to be about 45° or greater, about 50° or greater, about 55° or greater, about 60° or greater, about 65° or greater, about 70° or greater, about 75° or greater, about 80° or greater, about 85° or greater, about 90° or greater, about 95° or greater, about 100° or greater, or in ranges of about 45° to about 55°, about 50° to about 60°, about 55° to about 65°, about 60° to about 70°, about 65° to about 75°, about 70° to about 80°, about 75° to about 85°, about 80° to about 90°, about 85° to about 95°, or about 90° to about 100°.

The tapered countersink surface 118 may have a selected depth d. The depth d of the tapered countersink surface 118 is the minimum distance between the tapered countersink surface 118 and at least one of the top surface 106 or the cutting edge 114 measured parallel to the central axis 124. The depth d may be selected to be about 1.25 mm or less, about 1.25 mm or greater, about 1.3 mm or greater, about 1.4 mm or greater, about 1.5 mm or greater, about 1.6 mm or greater, about 1.7 mm or greater, about 1.8 mm or greater, about 1.9 mm or greater, about 2 mm or greater, about 2.2 mm or greater, about 2.4 mm or greater, about 2.6 mm or greater, about 2.8 mm or greater, about 3 mm or greater, about 3.25 mm or greater, about 3.5 mm or greater, about 3.75 mm or greater, about 4 mm or greater, about 4.5 mm or greater, about 5 mm or greater, or in ranges of about 1.25 mm to about 1.4 mm, about 1.3 mm to about 1.5 mm, about 1.4 mm to about 1.6 mm, about 1.5 mm to about 1.7 mm, about 1.6 mm to about 1.8 mm, about 1.7 mm to about 1.9 mm, about 1.8 mm to about 2 mm, about 1.9 mm to about 2.2 mm, about 2 mm to about 2.4 mm, about 2.2 mm to about 2.6 mm, about 2.4 mm to about 2.8 mm, about 2.6 mm to about 3 mm, about 2.8 mm to about 3.25 mm, about 3 mm to about 3.5 mm, about 3.25 mm to about 3.75 mm, about 3.5 mm to about 4 mm, about 3.75 mm to about 4.5 mm, or about 4 mm to about 5 mm.

It has been surprisingly found that increasing the depth d of the tapered countersink surface 118 increases the torque that may be applied to the fastener without or substantially without splitting the cutting element 100 or otherwise causing the cutting element 100 to fail, especially when the depth d is selected to be about 1.25 mm or greater or, more particularly, about 1.6 mm or greater. For example, it was expected that increasing the cross-sectional area of the cutting element 100 that is solid and does not form part of the opening 112 increases the ability of the cutting element 100 to resist splitting or failing when the fastener is torqued. Contrary to this expectation, it has been found that increasing the depth d of the tapered countersink surface 118 may improve the ability of the cutting element 100 to resist splitting or failing due to torqueing the fastener.

The depth d of the tapered countersink surface 118 may be selected based on a number of factors. In an example, the depth d may be selected based on the selected maximum torque that may be applied to the fastener. In an example, the depth d may be selected based on the countersink angle θ of the tapered countersink surface 118. For instance, the depth d may be increased (e.g., to be about 1.6 mm or greater or 2 mm or greater) when the countersink angle θ is selected to be about 40° to about 50°. In an example, the depth d may be selected based on the thickness of the superhard table 102 and whether the superhard table 102 forms or defines part of the tapered countersink surface 118. In an example, the depth d may be selected based on the width W of the superhard table 102 since the ability of the cutting element 100 to resist splitting or otherwise failing depends, at least in part, on the width W of the cutting element 100. In an example, the depth d may be selected based on whether the cutting element 100 includes the tapered bore surface 120, the tapered cutting feature surface 122, or another surface.

In an embodiment, the superhard table 102 forms or defines at least a portion of the tapered countersink surface 118. When the superhard table 102 includes PCD, it was conventionally thought to be desirable to minimize the percentage of the tapered countersink surface 118 that is formed by PCD since PCD may be more likely to split at a given torque than at least some materials. However, it has been found that the clamping force applied from the fastener to the cutting element 100 increases as the percentage of the tapered countersink surface 118 formed by the PCD. As such, increasing the percentage of tapered countersink surface 118 that is formed by the PCD may allow the torque applied to the fastener to be decreased, thereby decreasing the likelihood that the cutting element 100 splits or otherwise fails even when the at least a portion of the tapered countersink surface 118 is formed from PCD. In a particular example, the superhard table 102 forms or includes only a portion of the tapered countersink surface 118, such as about 1% to about 20%, about 10% to about 30%, about 20% to about 40%, about 30% to about 50%, about 40% to about 60%, about 50% to about 70%, about 60% to about 80%, about 70% to about 90%, or about 80% to about 99% of the surface area of the tapered countersink surface 118. In a particular example, the superhard table 102 forms or includes all of the tapered countersink surface 118. In an example, the substrate 104 forms or includes all of the tapered countersink surface 118.

The superhard table 102 may be a relatively thick superhard table 102 (e.g., exhibit a thickness that is about 3.75 mm or greater, about 4.25 mm or greater, about 5 mm or greater, or about 7 mm or greater). The thick superhard table 102 allows the tapered countersink surface 118 to exhibit any of the depths d disclosed herein and/or allows the superhard table 102 to form at least a portion of tapered countersink surface 118. For example, increasing the thickness of the superhard table 102 moves the interface 105 towards the bottom surface 108, which may allow the superhard table 102 to form at least a portion of the tapered countersink surface 118 even as the depth d of the tapered countersink surface 118 increases.

The superhard table 102 exhibits a width W. The width W is the smallest distance between opposing portions of the cutting edge 114. Generally, increasing the width W increases the cross-sectional area of the cutting element 100 that is solid which, in turn, may make it less likely that the cutting element 100 splits or otherwise fails as a torque load is applied to the fastener. For example, the superhard table 102 may exhibit a width W that is about 8 mm or greater, about 8.5 mm or greater, about 9 mm or greater, about 9.5 mm or greater, about 10 mm or greater, about 10.5 mm or greater, about 11 mm or greater, about 12 mm or greater, about 12.5 mm or greater, or in ranges of about 8 mm to about 9 mm, about 8.5 mm to about 9.5 mm, about 9 mm to about 10 mm, about 9.5 mm to about 10.5 mm, about 10 mm to about 11 mm, about 10.5 mm to about 11.5 mm, about 11 mm to about 12 mm, or about 11.5 mm to about 12.5 mm. In an embodiment, the width W may be selected to be greater than about 9.5 mm which causes the cutting element 100 to better prevent or inhibit splitting or failure thereof caused by torqueing the fastener than conventional cutting elements since at least some cutting elements exhibit a width that is less than 9 mm. In an embodiment, the width W may be selected based on the size of the pocket of the cutting tool body (e.g., pocket 546 of FIGS. 5A and 5B) to which the cutting element 100 is attached.

As previously discussed, the cutting element 100 may include the at least one tapered bore surface 120. The tapered bore surface 120 extends upwardly from the tapered countersink surface 118 or from a location nearly from the tapered countersink surface 118 when a chamfer or radiused surface is formed between the tapered countersink surface 118 and the tapered bore surface 120. The tapered bore surface 120 facilitates insertion and removal of the fastener from the opening 112 due to the tapered shape thereof. The tapered bore surface 120 also moves the tapered countersink surface 118 towards the bottom surface 108.

The tapered bore surface 120 may exhibit a bore angle α. The bore angle α is the smallest angle between opposing portions of the tapered bore surface 120. For example, the bore angle α may be double the smallest angle measured between the tapered bore surface 120 and the central axis 124. The bore angle α may be selected to be smaller than the countersink angle θ. The smaller angle α increases the cross-sectional area of the cutting element 100 that is formed from or defined by solid material than if the portions of the opening 112 defined by the tapered bore surface 120 are instead defined by the tapered countersink surface 118. In an embodiment, the angle α may be about 1° or greater, about 5° or greater, about 10° or greater, about 15° or greater, about 20° or greater, about 25° or greater, about 30° or greater, about 35° or greater, about 40° or greater, about 50° or greater, about 60° or greater, about 70° or greater, about 80° or greater, about 90° or greater, about 100° or greater, or in ranges of about 1° to about 10°, about 5° to about 15°, about 10° to about 20°, about 15° to about 25°, about 20° to about 30°, about 25° to about 35°, about 30° to about 40°, about 35° to about 50°, about 40° to about 60°, about 50° to about 70°, about 60° to about 80°, about 70° to about 90°, or about 80° to about 100°.

The cutting element 100 includes one or more cutting features. The cutting features of the cutting element 100 may include the at least one cutting edge 114, the top (i.e., rake) surface 106 extending inwardly from the cutting edge 114, and the at least one tapered cutting feature surface 122 extending inwardly from or nearly from the top surface 106. During operation, the cutting edge 114 and the top surface 106 may remove material from the workpiece. At least a portion of the removed material may move down at least a portion of the tapered cutting feature surface 122, for example, to form a ribbon of material. In an embodiment, the tapered cutting feature surface 122 may exhibit an angle measured between opposing portions thereof that is larger than the countersink angle θ and/or the bore angle α which facilitates formation of the ribbon. In an embodiment, the tapered cutting feature surface 122 may exhibit an angle measured between opposing portions thereof that is about 1° or greater, about 5° or greater, about 10° or greater, about 15° or greater, about 20° or greater, about 25° or greater, about 30° or greater, about 35° or greater, about 40° or greater, about 50° or greater, about 60° or greater, about 70° or greater, about 80° or greater, about 90° or greater, about 100° or greater, or in ranges of about 1° to about 10°, about 5° to about 15°, about 10° to about 20°, about 15° to about 25°, about 20° to about 30°, about 25° to about 35°, about 30° to about 40°, about 35° to about 50°, about 40° to about 60°, about 50° to about 70°, about 60° to about 80°, about 70° to about 90°, or about 80° to about 100°.

The cutting element 100 may include one or more features or surfaces in addition to the features and surfaces discussed above, such as features for breaking chips of material that are being removed from the workpiece. Examples of other features and surfaces (e.g., a lip) are disclosed in U.S. patent application Ser. No. 16/529,176, U.S. patent application Ser. No. 17/678,819, and U.S. Provisional Patent Application No. 63/318,663, the disclosure of each of which is incorporated herein, in its entirety, by this reference.

Various methods may be employed to form the opening 112, the surfaces defining the opening 112, or other geometric features of the cutting element 100, including processes such as laser machining and laser cutting. Some non-limiting methods of forming such features in the cutting element 100 are described in U.S. Pat. Nos. 9,089,900, 9,062,505, and PCT Patent Application No. PCT/US2018/013069, the disclosure of each of which is incorporated by reference herein in its entirety. Additionally, the cutting element 100 may be subjected to other processes to obtain desired characteristics or features. For example, at least a portion of a surface of the superhard table 102 may be polished (e.g., at least a portion of a PCD surface may be polished) to a finish of approximately 20 micro inches (u in) root mean square (RMS). Examples of surface finishing processes and tables with various surface finishes are described in U.S. patent application Ser. No. 15/232,780 filed on Aug. 9, 2016, the disclosure of which is incorporated by reference herein in its entirety.

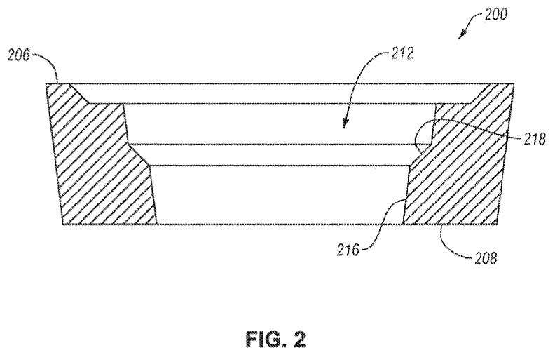

FIG. 2 is a cross-sectional view of a cutting element 200, according to an embodiment. Except as otherwise disclosed herein, one or more features of the cutting element 200 may be the same or substantially similar to any of the one or more features of the cutting elements disclosed herein. For example, the cutting element 200 defines an opening 212. The opening 212 is defined by at least one shaft surface 216 and at least one tapered countersink surface 218.

The cutting element 200 may comprise a superhard table 202, such as a PCD table. The cutting element 200 does not includes a substrate or other structure attached to the superhard table 202. In other words, in some embodiments, as previously noted, the cutting element 200 may comprise, it may consist of, or it may consist essentially of the superhard table 202. In an embodiment, the superhard table 202 may be initially formed with a substrate during an HPHT process (with the substrate providing a catalytic material such as previously described), and the substrate may be removed after the HPHT process. In an embodiment, the superhard table 202 may be formed by mixing a catalytic material with diamond powder or otherwise providing a catalytic material prior to an HPHT process. The superhard table 202 may be leached to have a metal-solvent catalyst or metallic infiltrant partially or substantially completely depleted from a selected surface or volume of the superhard table 202, such as via an acid leaching process.

In one particular example, the superhard table 202 may include a relatively “thick diamond” table which exhibits a thickness measured from the top surface 206 to the bottom surface 208 that is about 3.75 mm or greater, such as about 3.75 mm to about 4.25 mm, about 4 mm to about 4.5 mm, about 4.25 mm to about 4.75 mm, about 4.5 mm to about 5 mm, about 4.75 mm to about 5.5 mm, about 5 mm to about 6 mm, about 5.5 mm to about 6.5 mm, about 6 mm to about 7 mm, about 6.5 mm to about 7.5 mm, about 7 mm to about 8 mm, or about 7.5 mm or greater. The relatively thick diamond table allows the superhard table 202 to define all of the opening 212. For example, the relatively thick diamond table allows the superhard table 202 to define all of the tapered countersink surface 218 when the tapered countersink surface 218 exhibits any of the depths disclosed herein.

As previously discussed, the cutting elements disclosed herein may be used in cutting tools. Such cutting tools may be used in machining processes, including milling, drilling, turning, variations thereof, or combinations thereof. In a particular example, the cutting tools may be used in a computer numerical control machine, a vertical milling machine, or a horizontal milling machine. The cutting tools including the cutting elements disclosed herein may be used in shaping, forming, and finishing a variety of different materials, including material that are often difficult to machine, including, for example, titanium, titanium alloys, aluminum, and nickel-based materials. In an embodiment, the cutting tool is not configured to be used subterranean drilling (e.g., does not form at least a portion of a subterranean drill bit).

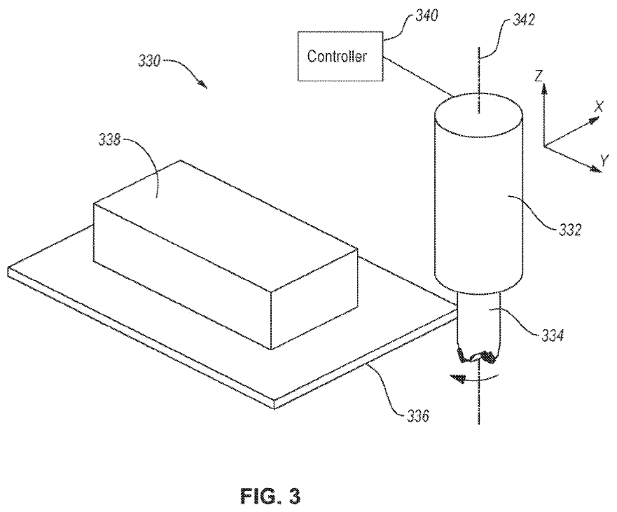

FIG. 3 is a schematic illustration of a vertical milling machine (VMM) 330 and operation of the VMM 330, according to an embodiment. The VMM 330 includes a spindle 332 having a cutting tool 334 removably coupled therewith. The cutting tool 334 includes at least one cutting element attached thereto that may be configured as any of the cutting elements disclosed herein. The VMM 330 also includes a table 336 on which a workpiece 338 is placed. A CNC (computer numerically controlled) controller 340 is in communication with the spindle 332 and may control the action of the spindle 332. While not expressly shown in FIG. 3, a frame may couple several of the components together (e.g., the spindle 332 and the table 336). The spindle 332 is configured to rotate the cutting tool 334 about an axis 342 and to also move the cutting tool 334 in the X, Y and Z directions relative to the table 336 and associated workpiece 338.

As noted above, the controller 340 is in communication with the spindle 332 and configured to control various operations of the VMM 330. For example, the controller 340 may be configured to control the rotational speed of the cutting tool 334 and also move the spindle 332 (and, thus, the cutting tool 334) in specified directions along the X-Y-Z axes at a desired “feed rate” relative to the workpiece 338. Thus, the controller 340 may enable the cutting tool 334 to remove material from the workpiece 338 so as to shape it and provide a desired surface finish to the workpiece 338 as will be appreciated by those of ordinary skill in the art.

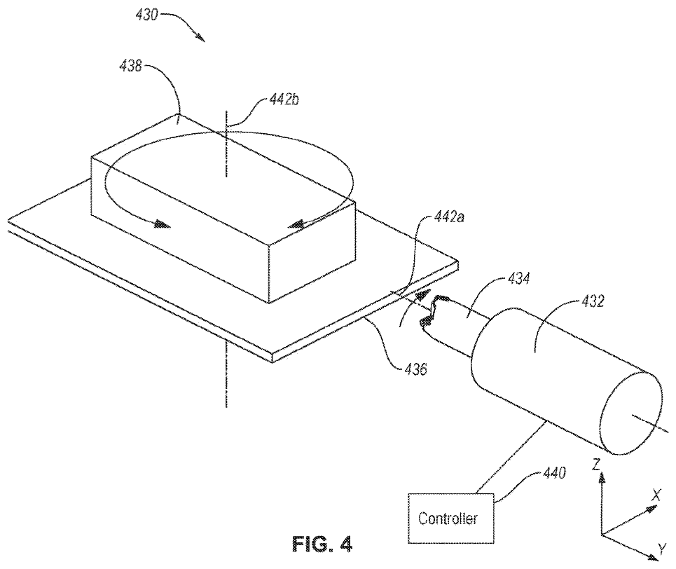

FIG. 4 is a schematic illustration of a horizontal milling machine (HMM) and operation of the HMM 430, according to an embodiment. The HMM 430 includes a spindle 432 having a cutting tool 434 removably coupled therewith. The cutting tool 434 includes at least one cutting element that is configured as any of the cutting elements disclosed herein. The HMM 430 also includes a table 436 on which a workpiece 438 is placed. The table 436 may be vertically oriented. A CNC controller 440 is in communication with the spindle 432 and controls the action of the spindle 432. In one embodiment, the controller 440 may also be in communication with the table 436 and/or spindle 432 to displace one or both in a desired direction, respectively, as discussed below. While not expressly shown in FIG. 4, a frame may couple several of the components together (e.g., the spindle 432 and the table 436). The spindle 432 is configured to rotate the cutting tool 434 about an axis 442a and to also move the cutting tool 434 in the X, Y and Z directions relative to the table 436 and the associated workpiece 438. Additionally, the table 436 may be configured to rotate about a B-axis 442b, which is substantially orthogonal to the rotational axis 442a. In one embodiment, the controller 440 may be configured to control the rotational speed of the cutting tool 434, displace the spindle 432 (and, thus, the cutting tool 434) in a specified direction and at a desired “feed rate” relative to the workpiece 438, and also rotate the table 436 (and thus the workpiece 438). Thus, the controller 440 may enable the cutting tool 434 to remove material from the workpiece 438 so as to shape it and provide a desired surface finish to the workpiece 438 as will be appreciated by those of ordinary skill in the art.

It is noted that the milling machines 330 and 430 described with respect to FIGS. 3 and 4 are merely examples, and that a variety of other machining systems are contemplated as incorporating a cutting tool such as is described in further detail below for use in a variety of machining operations.

FIGS. 5A and 5B are isometric and side elevational views, respectively, of a cutting tool 534, according to an embodiment. The cutting tool 534 may be used, for example, in the milling machines 330 and 430 of FIGS. 3 and 4. The cutting tool 534 includes a tool body 544 and a plurality of cutting elements 500. At least one of the cutting element 500 is configured as any of the cutting elements disclosed herein. The cutting elements 500 may be disposed in pockets 546 formed in an end or region of the tool body 544. In some embodiments, the cutting elements 500 may be removably coupled with the tool body 544 such as by a fastener 548. In some embodiments, the cutting elements 500 may be removably coupled with the body 544 using clamping mechanisms. In some embodiments, the cutting elements 500 may be coupled with the body 544 by brazing or other material joining techniques.

Various materials may be used in forming the body 544 of the cutting tool including various metals and metal alloys. In some embodiments, the body 544 may comprise an aluminum or aluminum alloy material. Other materials that may comprise the tool body include, without limitation, steel and steel alloys (e.g. stainless steels), nickel and nickel alloys, titanium and titanium alloys, tungsten and tungsten alloys, tungsten carbide and associated alloys, other metals, ceramics, composites, or combinations thereof.

While the cutting elements 500 and the cutting tool 534 may be used in a variety of machining processes, and for machining of a variety of materials, it has been determined that use of cutting elements 500 having a PCD table combined with a tool body 544 comprising aluminum unexpectedly may provide various benefits when machining a workpiece formed of titanium. While the exact mechanisms for improved efficiency and effectiveness of the machining of titanium are not entirely understood, it is believed that the use of an aluminum tool body may provide enhanced thermal conductivity of the cutting tool 534 which may result in an enhanced performance of the machining process.

In some embodiments, the cutting elements 500 may be beneficial in machining other thermal resistance materials. For example, in some embodiments, the cutting elements 500 of the present disclosure may provide advantages in machining materials having a thermal conductivity of less than approximately 50 watts per meter-Kelvin (W/m·K). In some embodiments, the cutting elements 500 of the present disclosure may be beneficial in machining materials having a thermal conductivity of less than approximately 30 W/m. K. In some embodiments, the cutting elements 500 of the present disclosure may be beneficial in machining materials having a thermal conductivity of less than approximately 20 W/m·K.

While various aspects and embodiments have been disclosed herein, other aspects and embodiments are contemplated. The various aspects and embodiments disclosed herein are for purposes of illustration and are not intended to be limiting.

Terms of degree (e.g., “about,” “substantially,” “generally,” etc.) indicate structurally or functionally insignificant variations. In an example, when the term of degree is included with a term indicating quantity, the term of degree is interpreted to mean ±10%, ±5%, or ±2% of the term indicating quantity. In an example, when the term of degree is used to modify a shape, the term of degree indicates that the shape being modified by the term of degree has the appearance of the disclosed shape. For instance, the term of degree may be used to indicate that the shape may have rounded corners instead of sharp corners, curved edges instead of straight edges, one or more protrusions extending therefrom, is oblong, is the same as the disclosed shape, etc.

What is claimed is:

1. A cutting element, comprising:
a superhard table defining at least one cutting edge;
a top surface at least partially defined by the superhard table;
a bottom surface opposite the top surface;
at least one lateral surface extending from or nearly from the top surface to or nearly to the bottom surface; and
an opening extending from the top surface to the bottom surface that is spaced from the at least one lateral surface, the opening at least partially defined by:
at least one shaft surface extending from or nearly from the bottom surface; and
at least one tapered countersink surface extending from or nearly from the at least one shaft surface, the at least one tapered countersink surface exhibiting a countersink angle measured between opposing portions of the at least one tapered countersink surface that is greater than about 45°.

2. The cutting element of claim 1 wherein all of the top surface, the bottom surface, the at least one lateral surface, the at least one shaft surface, and the at least one tapered countersink surface is formed by the superhard table.

3. The cutting element of claim 1 wherein the superhard table forms at least a portion of the at least one tapered countersink surface.

4. The cutting element of claim 1 wherein the superhard table forms all of the at least one tapered countersink surface.

5. The cutting element of claim 1 wherein the superhard table exhibits a thickness of about 5 mm or greater.

6. The cutting element of claim 1 wherein the countersink angle is greater than about 60°.

7. The cutting element of claim 6 wherein the countersink angle is about 60° to about 90°.

8. The cutting element of claim 1 wherein the at least one tapered countersink surface exhibits a depth of about 1.25 mm or greater, wherein the depth of the at least one tapered countersink surface is a minimum distance measured from the at least one cutting edge to the at least one tapered countersink surface measured parallel to a central axis of the superhard table.

9. The cutting element of claim 8 wherein the depth of the at least one tapered countersink surface is about 1.6 mm or greater.

10. The cutting element of claim 1 wherein the superhard table exhibits a width extending between opposing portions of the at least one cutting edge is about 9.5 mm or greater.

11. The cutting element of claim 1 wherein the superhard table further includes at least one tapered bore surface extending from or nearly from the at least one tapered countersink surface, the at least one bore tapered surface exhibiting a bore angle measured between opposing portions of the at least one bore tapered surface that is less than the countersink angle.

12. The cutting element of claim 1 wherein the superhard table further includes at least one tapered cutting feature surface extending generally inwardly from the top surface.

13. The cutting element of claim 1, further comprising a substrate attached to the superhard table.

14. The cutting element of claim 13 wherein the substrate defines at least a portion of the at least one tapered countersink surface.

15. The cutting element of claim 13 wherein the superhard table includes polycrystalline diamond and the substrate includes a tungsten carbide substrate.

16. The cutting element of claim 1 wherein the cutting element does not include a substrate.

17. A cutting tool, comprising:
a cutting tool body;
at least one cutting element attached to the cutting tool body, the at least one cutting element including a superhard table, the at least one cutting element including:
at least one cutting edge;
at least one shaft surface; and
at least one tapered countersink surface extending from or nearly from the at least one shaft surface, the at least one tapered countersink surface exhibiting a countersink angle measured between opposing portions of the at least one tapered countersink surface that is greater than about 45°; and
a fastener attaching the at least one cutting element to the cutting tool body, the fastener including a shaft and a head having a tapered surface at least partially abutting the at least one tapered countersink surface.

18. The cutting tool of claim 17 wherein a depth of the at least one tapered countersink surface is about 1.25 mm or greater wherein the depth of the at least one tapered countersink surface is a minimum distance measured from the at least one cutting edge to the at least one tapered countersink surface measured parallel to a central axis of the superhard table.

19. A method of removing material from a workpiece, the method comprising:
providing a cutting tool, the cutting tool comprising:
a cutting tool body;
at least one cutting element, the at least one cutting element includes a superhard table, the at least one cutting element including:
at least one cutting edge;
at least one shaft surface; and
at least one tapered countersink surface extending from or nearly from the at least one shaft surface, the at least one tapered countersink surface exhibiting a countersink angle measured between opposing portions of the at least one tapered countersink surface that is greater than about 45°; and
a fastener attaching the at least one cutting element to the cutting tool body, the fastener including a shaft and a head having a tapered surface at least partially abutting the at least one tapered countersink surface;
rotating at least one of the cutting tool or the workpiece about an axis; and
engaging the workpiece with the cutting tool.

20. The method of claim 19 wherein engaging a workpiece includes engaging a workpiece comprising titanium.
